(19) United States
(12) Patent Application Publication
(10) Pub. No.: US 2016/0239138 A1
(43) Pub. Date: Aug. 18, 2016

(54) MOBILE DEVICE, PRESS DETECTION METHOD AND COMPUTER-READABLE RECORDING MEDIUM

(71) Applicant: HTC Corporation, Taoyuan City (TW)

(72) Inventors: Yu-Hsin Liang, Taoyuan City (TW); Shih-Hung Chu, Taoyuan City (TW)

(21) Appl. No.: 14/623,505

(22) Filed: Feb. 17, 2015

(51) Int. Cl. G06F 3/041; G06F 3/046; G06F 1/16; H04W 88/02

(52) U.S. Cl. CPC G06F 3/0416; H04W 88/02; G06F 3/0414; G06F 3/046; G06F 1/1692

(57) ABSTRACT

A mobile device, a corresponding press detection method and a corresponding computer-readable recording medium are provided. The mobile device includes a back cover and a body. The back cover includes a plurality of inductor coils. The housing of the body includes a conductor at the position corresponding to each inductor coil. The mobile device generates magnetic fields by supplying power to the inductor coils. The mobile device detects presses received by the back cover according to variation of the magnetic fields induced by variation of the distance between the inductor coils and the conductor. The mobile device detects at least one press patterns and executes a corresponding function when a press pattern occurs. Each press pattern is corresponding to a subset of the inductor coils of the back cover and specifies the press state of the sensing area at the back cover for each inductor coil in the subset.

### BACKGROUND OF THE INVENTION

1. Field of the Invention

The present invention generally relates to a press detection technique, in particular, to a mobile device and its corresponding press detection method and computer-readable recording medium.

2. Description of Related Art

A screen of a mobile device such as a smart phone or a tabular computer is normally a rectangle, but not a square. When the mobile device executes different applications, it is often held in portrait or in landscape by the user. The existing mobile device may automatically determine whether itself is in a portrait mode or in a landscape mode, and switch a user interface accordingly.

However, the existing mobile device only determines whether itself is in the portrait mode or in the landscape mode by using a G-sensor, and yet a false determination may be easily made by the G-sensor and may trouble the user. Sometimes the user would even have to disable the portrait mode or the landscape through software or hardware keys for a correct user interface presentation.

### SUMMARY OF THE INVENTION

The present invention is directed to a mobile device and its corresponding press detection method and computer-readable recording medium so as to solve the aforesaid false determination problem.

The mobile device of the invention includes a back cover and a main body. The back cover includes a plurality of inductor coils. The main body is coupled to the back cover and includes a housing. The housing includes a conductor at a position corresponding to each of the inductor coils. The mobile device generates magnetic fields by supplying power to the inductor coils and detects a press received by the back cover according to a variation of the magnetic fields induced by a variation of a distance between the inductor coils and the conductor. The mobile device detects at least one press patterns, and when any press pattern among the at least one press patterns occurs, the mobile device executes a function corresponding to the press pattern. Each of the at least one press patterns corresponds to a subset of the inductor coils and specifies a press state of a sensing area at the back cover for each of the inductor coils in the subset.

The press detection method of the invention is adapted to the mobile device and includes the following steps: detecting at least one press patterns; and when any press pattern among the at least one press patterns occurs, executing a function corresponding to the press pattern.

The computer-readable recording medium of the invention records a computer program. When a mobile device loads and executes the computer program, the aforesaid press detection method is able to be completed.

The inductor coils of the back cover in conjunction with a G-sensor may solve a false determination of the mobile device being held. Moreover, the back cover may be used as an input interface of the mobile device for more convenient applications.

### BRIEF DESCRIPTION OF THE DRAWINGS

FIG. 1 illustrates a schematic diagram of a mobile device according to an embodiment of the invention.

FIG. 2 illustrates a schematic diagram of a side view of a mobile device according to an embodiment of the invention.

FIG. 3 illustrates a schematic diagram of a side view of a mobile device according to another embodiment of the invention.

FIG. 4 illustrates a schematic diagram of a press detection method according to an embodiment of the invention.

FIGS. 5-8 illustrate schematic diagrams of multiple press patterns according to multiple embodiments of the invention.

### DESCRIPTION OF THE EMBODIMENTS

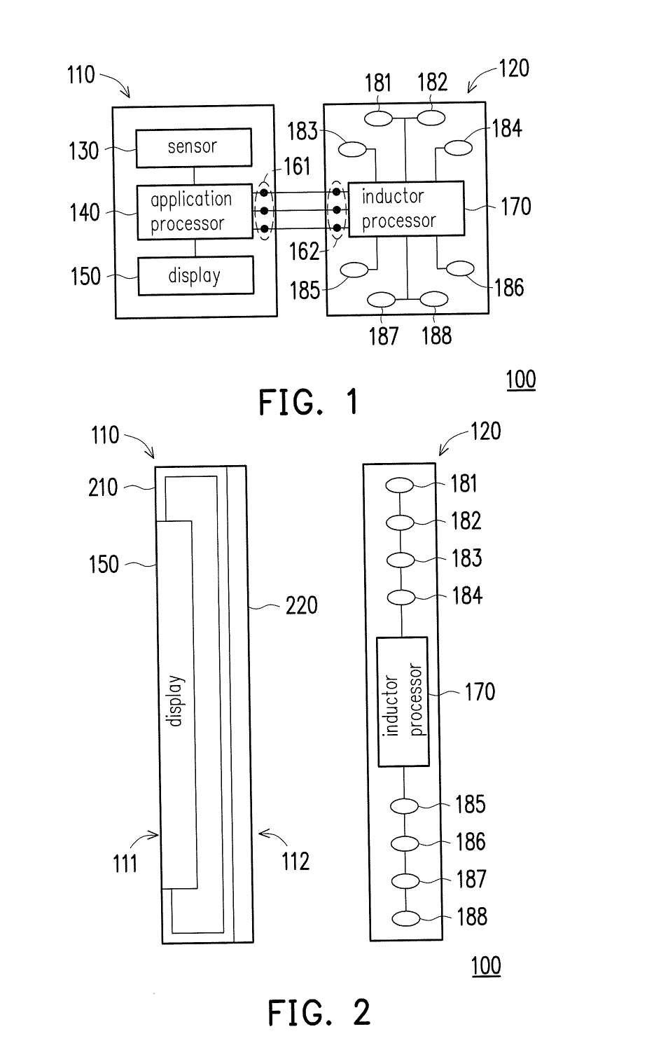

FIG. 1 illustrates a schematic diagram of a mobile device 100 according to an embodiment of the invention. A mobile device 100 may be a smart phone, a personal digital assistant, or a tabular computer. The mobile device 100 includes a main body 110 and a back cover 120. The back cover 120 may be added onto the main body 110 through a mechanical design such as a groove or a tenon, where the back cover 120 and the main body 110 are coupled to each other. The back cover 120 may be detachable from the main body 110.

The main body 110 includes a sensor 130, an application processor 140, and a display 150, where the application processor 140 is coupled to the sensor 130 and the display 150. The sensor 130 may detect whether the mobile device 100 is held in portrait or in landscape. The application processor 140 may execute operation system and application software of the mobile device 100. The display 150 may display a user interface of the mobile device 100.

The back cover 120 includes an inductor processor 170 and inductor coils 181-188. The inductor processor 170 is coupled to the inductor coils 181-188. The inductor coils 181-188 may detect presses onto the back cover 120 performed by the user. The inductor processor 170 may control and read outputs of the inductor coils 181-188. Although the back cover 120 in FIG. 1 includes eight inductor coils 181-188, the back cover 120 may also include any number of inductor coils in another embodiment of the invention.

The main body 110 further includes three touch points 161, and the back cover 120 further includes three touch points 162. The application processor 140 and the inductor processor 170 are coupled to each other through the touch points 161 and 162 so as to transmit commands and data to each other. Either the touch points 161 or the touch points 162 are metal electrodes, and the other ones are elastic metal strips or extendable metal needles. When the back cover 120 is configured on top of the main body 110, the touch points 161 and 162 may contact to each other and form signal paths between the application processor 140 and the inductor processor 170. In other embodiments, the touch points 161 and 162 may be made by other semiconductor materials, and the number of the touch points 161 and 162 may be any integer.

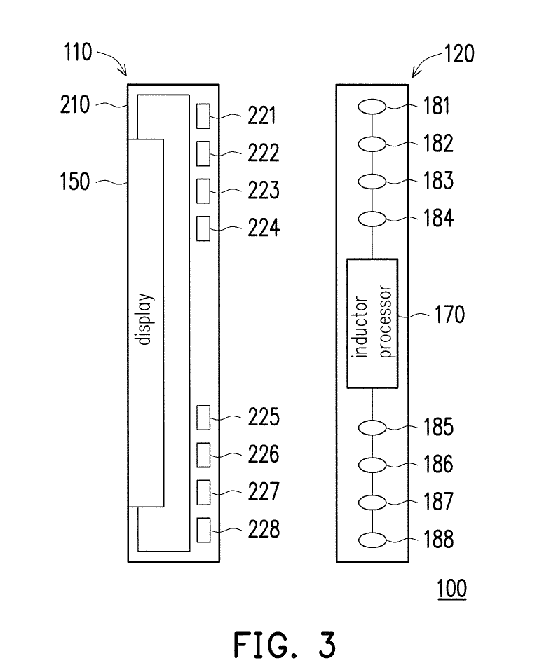

FIG. 2 illustrates a schematic diagram of a side view of the mobile device 100 according to an embodiment of the invention. In the present embodiment, the display 150 is configured on a first surface 111 of the main body 110, and the back cover 120 is a protective cover of a second surface 112 of the main body 110 opposite to the first surface 111. The main body 110 also includes a housing 210. A position on the housing 210 corresponding to the inductor coils 181-188 includes a conductor 220. The conductor 220 is configured on top of the second surface 112 of the main body 110 (i.e. on top of a back side of the housing 210). In fact, the conductor 220 corresponding to each of the inductor coils 181-188 is a same piece of conductor.

The mobile device 100 may supply power to the inductor coils 181-188, and each of the inductor coils 188-188 thereby generates a magnetic field. When the user presses the back cover 120, the back cover 120 would be deformed. Such deformation may result in the variation of the distance between the surrounding inductor coils and the conductor 220 and thus induces the variation of the aforesaid magnetic fields. The application processor 140 or the inductor processor 170 may detect presses received from the back cover 120 according to the variation of the magnetic fields.

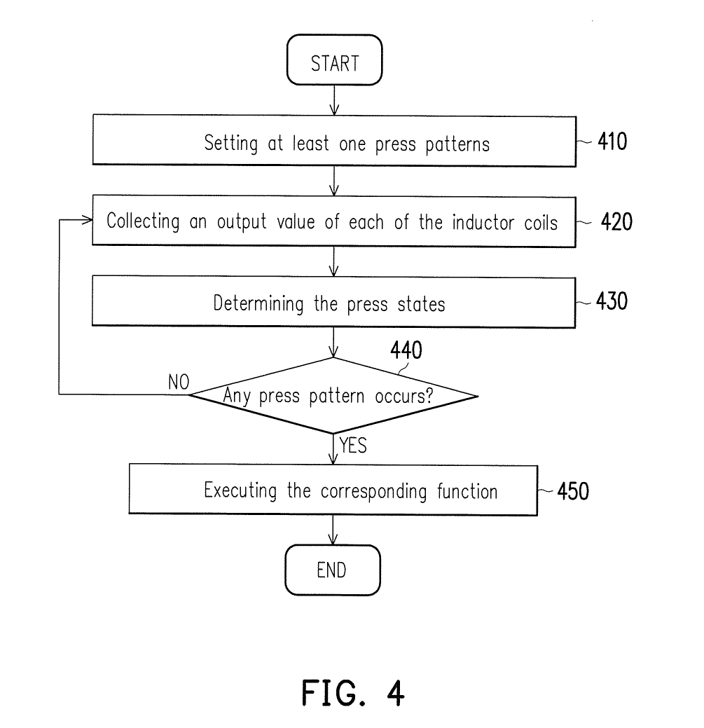

FIG. 3 illustrates a schematic diagram of a side view of the mobile device 100 according to another embodiment of the invention. In the present embodiment, eight conductors 221-228 are embedded in the housing 210. The conductors 221-228 respectively correspond to the inductor coils 181-188 and are embedded at positions corresponding to the inductor coils 181-188. Distinguished from the previous embodiment with a single piece of the conductor 220, the conductors 221-228 are eight different conductors located at different positions in the present embodiment.

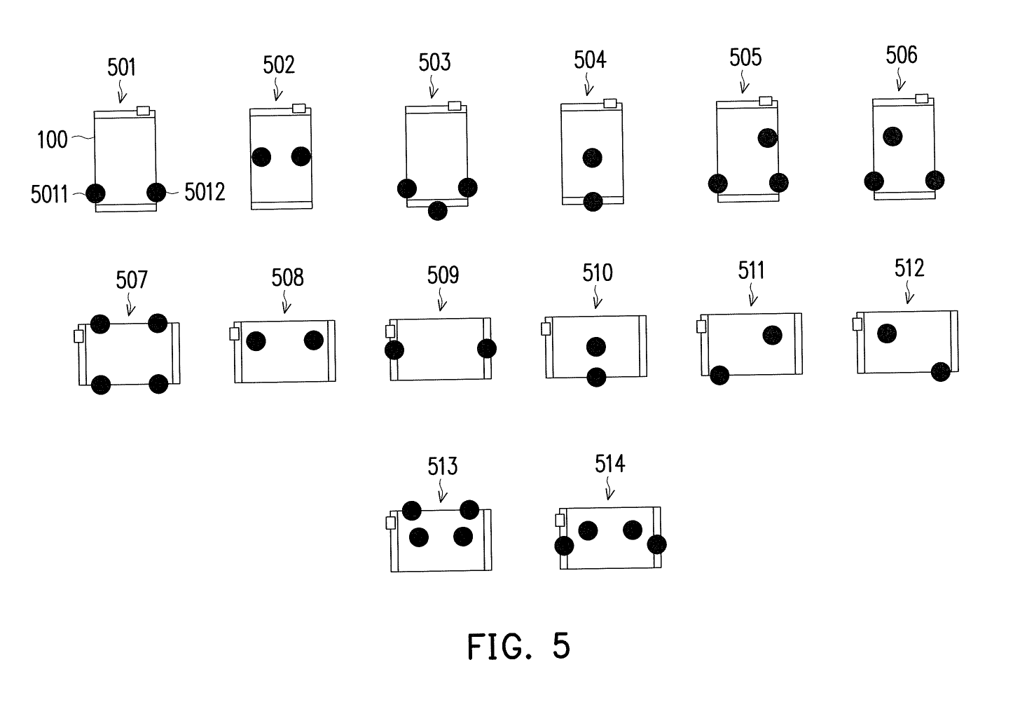

FIG. 4 illustrates a schematic diagram of a press detection method according to an embodiment of the invention, where such method may be executed by the application processor 140 and the inductor processor 170 of the mobile device 100. In Step 410, the application processor 140 sets at least one press patterns through the inductor processor 170. Each of the press patterns corresponds to a subset of the inductor coils of the back cover 120 and specifies a press state of a sensing area at the back cover 120 for each of the inductor coils in the subset. The press state of each of the inductor coils may be a touch or a tap, where the tap may include a single tap, double taps, or three or more continuous rapid taps. The press patterns are used for detecting an operation performed on the back cover 120 by the user. In Step 410, the inductor processor 170 may enable the inductor coils specified by the press patterns and disables the inductor coils not specified by the press patterns.

In Step 420, the inductor processor 170 collects an output value of each of the inductor coils specified by the press patterns, where each of the output values is generated according to the magnetic field generated by the corresponding inductor coil. In Step 430, according to each of the output values, the inductor processor 170 determines the press state of the corresponding inductor coil. The inductor processor 170 may compare each of the output values with a preset threshold value. If any of the output values is greater than the threshold value, the sensing area of the corresponding inductor coil is determined to be touched or tapped given the corresponding output value greater than the threshold value with a continuous time.

Next, in Step 440, the inductor processor 170 detects whether any of the press patterns occurs. The inductor processor 170 may determine whether any press pattern among the aforesaid press patterns occurs according to the press states of the inductor coils specified by the press patterns. For each of the press patterns, if the press state of each of the inductor coils specified by the press pattern is satisfied, the press pattern occurs. If no press pattern occurs, the flow returns to Step 420. If any of the press patterns occurs, the inductor processor 170 would notify the application processor 140. In Step 450, the application processor 140 executes a function corresponding to the occurring press pattern.

In another embodiment, Step 440 may be executed by the application processor 140. To be specific, after Step 430, the application processor 140 may obtain the press states of the inductor coils determined by the inductor processor 170 therefrom. Next, the application processor 140 may determine whether any of the press patterns occurs according to the press states in Step 440. If any of the press patterns occurs, the application processor 140 executes a function corresponding to the occurring press pattern in Step 340.

In another embodiment, Steps 430 and 440 may be executed by the application processor 140. To be specific, after Step 420, the application processor 140 may obtain the output values collected by the inductor processor 170 therefrom. Next, according to each of the output values, the application processor 140 may determine the press state of the corresponding inductor coil in Step S430, ad determine whether any of the press patterns occurs according to the press states of the conductor coils. If any of the press patterns occurs, the application processor 140 executes a function corresponding to the press pattern in Step 450.

Several embodiments of press patterns set by the application processor 140 along with functions corresponding to the press patterns are illustrated as examples hereafter.

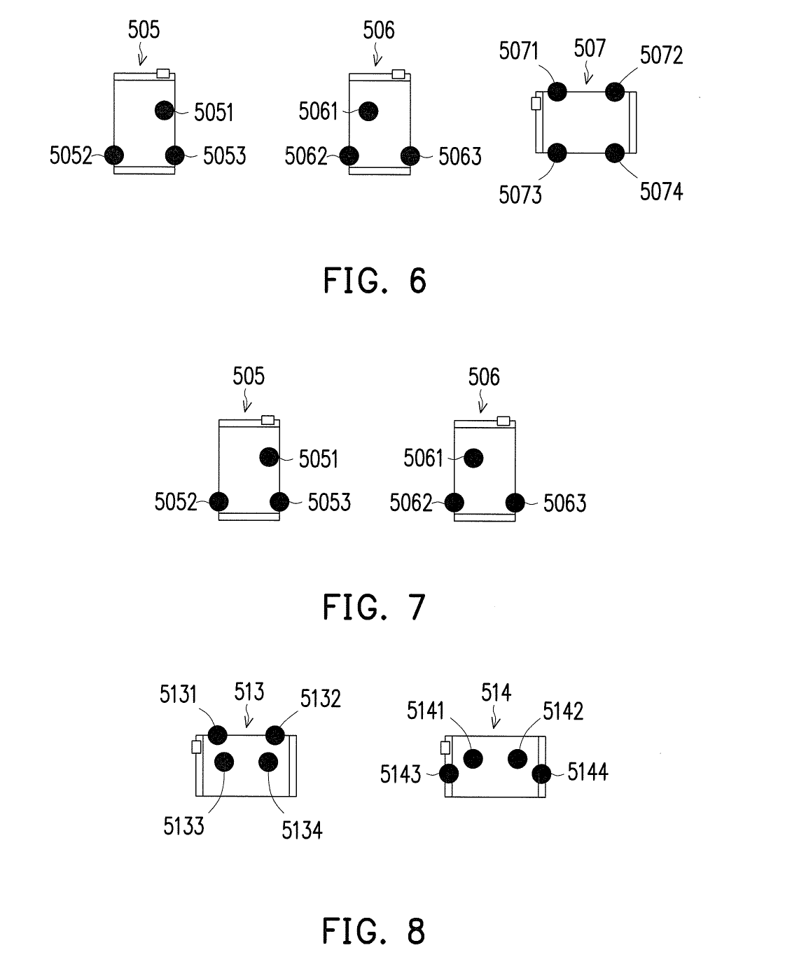

FIG. 5 illustrates schematic diagrams of press patterns 501-514 according to an embodiment of the invention. Each of the press patterns 501-514 corresponds to a subset of a plurality of inductor coils, and the press state of the sensing area at the back cover 120 for each of the inductor coils in the subset is specified as a touch. For example, the subset corresponding to the press pattern 501 includes two inductor coils, where sensing areas of the two inductor coils are respectively labelled as 5011 and 5012. When the sensing areas 5011 and 5012 are touched concurrently, the mobile device 100 determines that the press pattern 501 occurs and executes a function corresponding to the press pattern 501. The other press patterns 502-514 may be deduced in a similar fashion. The press patterns 501-514 are used for determining the way of the mobile device 100 is being held. The press patterns 501-514 and a corresponding holding way of each of the press patterns are listed in the following tables. When a press pattern occurs, it represents that the current holding way of the mobile device is the holding way corresponding to the press pattern.

| press pattern | corresponding holding way |
|---|---|
| 501 | ordinary portrait |
| 502 | portrait, held by two hands |
| 503 | portrait, held by cradle |
| 504 | portrait on table |
| 505 | portrait, held by left hand |
| 506 | portrait, held by right hand |
| 507 | ordinary landscape |
| 508 | landscape, held by two hands |
| 509 | landscape, held by cradle |
| 510 | landscape on table |
| 511 | landscape, held by left hand |
| 512 | landscape, held by right hand |
| 513 | multimedia application A |
| 514 | multimedia application B |

The “base stand” listed in the above table means that the mobile device 100 is placed on a cradle for vehicles. The “table” listed in the above table means that the mobile device 100 is placed on a flat surface such as a table and stands with support of a small object. After the holding way is determined, the application processor 140 of the mobile device 100 may execute the corresponding function. For example, when the mobile device 140 is placed on a cradle, the application processor 140 may switch the user interface of the mobile device 100 to a specially-designed vehicle mode. The corresponding function may also be launching preset launching application software corresponding to the current holding way. For example, when the press pattern 507 occurs, the application processor 140 may launch preset video shooting or recording application software. When the press pattern 513 or 514 occurs, the application processor 140 may launch a preset multimedia player or gaming software. Hence, the back cover 120 may be implemented as a touch input interface of the mobile device 100 so that the mobile device 100 may offer more flexible functions and applications.

FIG. 6 illustrates schematic diagrams of press patterns according to an embodiment of the invention. In the present embodiment, the application processor 140 sets the three press patterns 505-507 in FIG. 5. The press pattern 505 specifies a press state of each sensing area 5051-5053 of three inductor coils as a touch. The press pattern 506 specifies a press state of each sensing area 5061-5063 of three inductor coils as a touch. The press pattern 507 specifies a press state of each sensing area 5071-5073 of four inductor coils as a touch.

In the present embodiment, when the press pattern 505 or 506 occurs, the application processor 140 may switch the user interface of the mobile device 100 to a portrait mode. When the press pattern 507 occurs, the application processor 140 may switch the user interface of the mobile device 100 to a landscape mode.

After the press pattern 505 occurs, the application processor 140 may further set a press pattern, and the press pattern may specify a press state of the sensing area 5051 as a tap, where the corresponding function is to capture images. When the user holds the mobile device 100 with the left hand which satisfies the press pattern 505, he/she may immediately capture images by touching the sensing area 5051 of the back cover 120 with the left hand. This is a convenient image capturing function, where the user is allowed to immediately capture images without changing holding poses.

Similarly, when the press pattern 506 occurs, the application processor 140 may further set a press pattern, and the press pattern may specify a press state of the sensing area 5061 as a tap, where the corresponding function is to capture images. When the user holds the mobile device 100 with the right hand which satisfies the press pattern 506, he/she may immediately capture images by tapping the sensing area 5061 of the back cover 120 with the right hand.

Similarly, when the press pattern 507 occurs, the application processor 140 may further set a press pattern, and the press pattern may specify a press state of the sensing area 5072 as a tap, where the corresponding function is to capture images. When the user holds the mobile device 100 in landscape which satisfies the press pattern 507, he/she may immediately capture images by tapping the sensing area 5072 of the back cover 120 with the right hand.

The mobile device 100 may only determine the way of being held through a press pattern. In such condition, the sensor 130 may be neglected, and yet a false determination may occur. If only the sensor 130 is used for determining the holding way, a false determination may also occur. If the press pattern and the sensor 130 are both used, the accuracy of determining the holding way would be increased. The sensor 130 may be a sensor capable for sensing the way of the mobile device 100 being held such as a G-sensor, a Gyro-sensor, or an e-compass. It is only when the output of the sensor 130 satisfies a preset condition and any of the press patterns 505-507 occurs that the sensor 130 executes a function corresponding to the press pattern. The preset condition may be the holding way corresponding to the press pattern which satisfies the output of the sensor 130.

FIG. 7 illustrates schematic diagrams of press patters according to another embodiment of the invention. In the present embodiment, the application processor 140 sets the two press patterns 505 and 506 in FIG. 5. The press pattern 505 and 506 illustrated in FIG. 7 are the same as those illustrated in FIG. 6. When the press pattern 505 occurs, it means that the user is holding the mobile device 100 with the left hand, and the application processor 140 may switch the user interface of the mobile device 100 to a left-hand mode. The left-hand mode is to display the user interface close to the left thumb or within a range operable by the left thumb for a convenient one-hand (left-hand) operation.

Similarly, when the press pattern occurs 506, the application processor 140 may switch the user interface of the mobile device 100 to a right-hand mode. The right-hand mode is to display the user interface close to the right thumb or within a range operable by the right thumb for a convenient one-hand (right-hand) operation. As the screen sizes of mobile devices increase, it is difficult to perform a one-hand operation. The aforesaid left-hand mode and the right-hand mode may present a user interface suitable for a one-hand operation.

Various simple operations are provided to wake up an existing mobile device from a sleep mode such as picking up the mobile device or tapping twice on its display. However, there is no simple operation to allow the existing device to immediately enter the sleep mode. The user may only make the mobile device enter the sleep mode by pressing its power button or by waiting the mobile device to idle. Thus, the sleep mode of the mobile device is easy to be released but difficult to be entered.

To solve such problem, when the press pattern 505 occurs, the application processor 140 may further set a press pattern, where such press pattern may specify the press state of the sensing area 5051 to be double taps with entering the sleep mode as its corresponding function. While the user is holding the mobile device 100 with the left hand which satisfies the press pattern 505, he/she may rapidly tap the sensing area 5051 twice by the left hand so as to allow the mobile device 100 to enter the sleep mode. In such approach, the user is allowed to immediately perform the operation without changing holding poses.

Similarly, when the press pattern 506 occurs, the application processor 140 may further set a press pattern, where such press pattern may specify the press state of the sensing area 5061 to be double taps with entering the sleep mode as its corresponding function. While the user is holding the mobile device 100 with the right hand which satisfies the press pattern 506, he/she may rapidly tap the sensing area 5061 twice by the right hand so as to allow the mobile device 100 to enter the sleep mode.

FIG. 8 illustrates schematic diagrams of press patterns according to another embodiment of the invention. In the present embodiment, the application processor 140 sets the two press pattern 513 and 514 in FIG. 5. The press pattern 513 specifies press states of sensing areas 5131-5134 of four inductor coils to be touches. The press pattern 514 specifies press states of sensing areas 5141-5144 of four inductor coils to be touches.

When the press pattern 513 or 514 occurs, the application processor 140 may launch a preset multimedia player or gaming software. The application processor 140 may set more press matters and their corresponding functions according to one or more of the sensing areas of the press pattern 513 or 514 so as to provide the user to conveniently play the multimedia player or gaming software. The sensing areas on top of the back cover 120 may replace physical buttons of the mobile device 100 so as to allow the mobile device 100 to have much more space for accommodating a display with a larger size.

Besides the aforesaid mobile device and the press detection method, a computer-readable recording medium is also provided in the invention. Such recording medium may be a physical storage device such as a memory, a soft disk, a hard disk, or a disk for storing computer program. When the mobile device loads and executes the computer program, the aforesaid press detection method may be completed.

In view of the foregoing, in the invention, at least one press patterns of the back cover may be set in the mobile device. The user's operation is detected through the back cover of the mobile device and the corresponding function is then performed. Additionally, the holding way of the mobile device may be detected through the back cover, and the sensor may provide a more accurate rate for detecting the holding way.

What is claimed is:

1. A mobile device comprising:
a back cover, comprising a plurality of inductor coils; and
a main body, coupled to the back cover and comprising a housing, wherein the housing comprises a conductor at a position corresponding to each of the inductor coils, wherein the mobile device generates magnetic fields by supplying power to the inductor coils and detects a press received by the back cover according to variation of the magnetic fields induced by variation of a distance between the inductor coils and the conductor, wherein the mobile device detects at least one press patterns, wherein when any press pattern among the at least one press patterns occurs, the mobile device executes a corresponding function, and wherein each of the at least one press patterns corresponds to a subset of the inductor coils and specifies a press state of a sensing area at the back cover for each of the inductor coils in the subset.

2. The mobile device according to claim 1, wherein the main body further comprises a display configured on a first surface of the main body, and wherein the back cover is a protective cover of a second surface opposite to the first surface.

3. The mobile device according to claim 2, wherein the conductor is configured on the second surface.

4. The mobile device according to claim 1, wherein the conductor is embedded in the housing.

5. The mobile device according to claim 1, wherein the conductor corresponding to each of the inductor coils is a same conductor.

6. The mobile device according to claim 1, wherein the conductor corresponding to each of the inductor coils is a different conductor located at a different position.

7. The mobile device according to claim 1, wherein before detecting the at least one press patterns, the mobile device enables the inductor coils specified by the at least one press patterns and disables the inductor coils not specified by the at least one press patterns.

8. The mobile device according to claim 1, wherein each of the press states is a touch or a tap.

9. The mobile device according to claim 1, wherein the main body further comprises a sensor, and wherein only when an output of the sensor satisfies a preset condition and any press pattern among the at least one press patterns occurs, the mobile device executes the function corresponding to the press pattern.

10. The mobile device according to claim 1, wherein
the back cover further comprises:
an inductor processor, coupled to the inductor coils, and collecting an output value of each of the inductor coils specified by the at least one press patterns, wherein each of the output values is generated according to the magnetic field generated by the corresponding inductor coil; and wherein
the main body further comprises:
an application processor, coupled to the inductor processor, wherein when any press pattern among the at least one press patterns occurs, the application processor executes the function corresponding to the press pattern.

11. The mobile device according to claim 10, wherein
according to each of the output values, the inductor processor determines the press state of the corresponding inductor coil, wherein
according to each of the press states, the inductor processor determines whether any press pattern among the at least one patterns occurs, and wherein
the inductor processor notifies the application processor when any press pattern among the at least one press patterns occurs.

12. The mobile device according to claim 10, wherein
according to each of the output values, the inductor processor determines the press state of the corresponding inductor coil,
the application processor obtains each of the press states from the inductor processor, and
according to each of the press states, the application processor determines whether any press pattern among the at least one press patterns occurs.

13. The mobile device according to claim 10, wherein
the application processor obtains each of the output values from the inductor processor,
according to each of the output values, the application processor determines the press state of the corresponding inductor coil, and
according to each of the press states, the application processor determines whether any press pattern among the at least one patterns occurs.

14. A press detection method, adapted to a mobile device, comprising:
detecting at least one press patterns; and
when any press pattern among the at least one press patterns occurs, executing a function corresponding to the press pattern, wherein the mobile device comprises a back cover and a main body, wherein the back cover comprises a plurality of inductor coils, wherein the main body comprises a housing, wherein the housing comprises a conductor at a position corresponding to each of the inductor coils, wherein the inductor coils generate a magnetic field, wherein a press received by the back cover is detected according to variation of the magnetic field induced by variation of a distance between the inductor coils and the conductor, and wherein each of the at least one press patterns corresponds to a subset of the inductor coils and specifies a press state of a sensing area at the back cover for each of the inductor coils in the subset.

15. The press detection method according to claim 14 further comprising:
before detecting the at least one press patterns, enabling the inductor coils specified by the at least one press patterns and disabling the inductor coils not specified by the at least one press patterns.

16. The press detection method according to claim 14, wherein each of the press states is a touch or a tap.

17. The press detection method according to claim 14, wherein the main body further comprises a sensor, and wherein the press detection method further comprises:
only when an output of the sensor satisfies a preset condition and any press pattern among the at least one press patterns occurs, executing the function corresponding to the press pattern.

18. The press detection method according to claim 14, wherein the step of detecting the press pattern comprises:
collecting an output value of each of the inductor coils specified by the at least one press patterns, wherein each of the output values is generated according to the magnetic field generated by the corresponding inductor coil;
according to each of the output values, determining the press state of the corresponding inductor coil; and
according to each of the press states, the inductor processor determines whether any press pattern among the at least one patterns occurs.

19. A computer-readable recording medium, storing a computer program, wherein when a mobile device loads and executes the computer program, the press detection method of claim 14 can be completed.
